(19) United States
(12) Patent Application Publication
(10) Pub. No.: US 2005/0229681 A1
(43) Pub. Date: Oct. 20, 2005

(54) Gas permeation method for porous membrane

(76) Inventors: Fumihiko Yamaguchi, Nobeoka-shi (JP); Naoko Hamasaki, Nobeoka-shi (JP)

Correspondence Address: YOUNG & THOMPSON, 745 SOUTH 23RD STREET, 2ND FLOOR, ARLINGTON, VA, 22202, US

(21) Appl. No.: 11/069,988

(22) Filed: Mar. 3, 2005

(30) Foreign Application Priority Data
Mar. 3, 2004 (JP) 2004-059285

(51) Int. Cl. G01N 15/08

(52) U.S. Cl. 73/38

(57) ABSTRACT

An objective of the present invention is to provide a method which gas permeation, an integrity test, and pore size measurement for a porous membrane wetted with a hydrophilic solvent can be performed at a low pressure. The present invention achieves the above objective by a step of causing an amphiphilic liquid or a mixture of an amphiphilic liquid and a liquid with a surface tension of 5 to 20 mN/m to permeate through a porous membrane wetted with a hydrophilic solvent, a step of causing a liquid with a surface tension of 5 to 20 mN/m to permeate through the porous membrane, a step of causing a gas to permeate through the porous membrane at a pressure of 2.5 MPa or less, and a step of measuring the flow rate of the permeated gas or the pressure changed by the permeation of the gas.

### TECHNICAL FIELD

The present invention relates to a gas permeation method for a porous membrane. More particularly, the present invention relates to gas permeation for a porous membrane having a pore size of 100 nm or less and wetted with a hydrophilic solvent. The present invention also relates to an integrity test method or a pore size measurement method for a porous membrane carried out by using the gas permeation method.

### BACKGROUND ART

In the manufacture of blood products and biological products, a step of removing highly dangerous viruses such as an HIV, HBV, and HCV is indispensable. As the virus removal method, a porous membrane filter has been utilized. In the case of using the porous membrane filter, it is necessary to measure the virus removal capability by conducting an integrity test (see patent document 1 and patent document 2) before or after filtration in order to confirm whether or not the porous membrane filter has changed during filtration.

The major cause of deterioration of the virus removal capability of the porous membrane is considered to be a small number of large pores included in the pores existing in the membrane. Therefore, it is necessary to determine the properties of the large pores in order to accurately evaluate the virus removal capability. As an integrity test for evaluating the large pores, a bubble point test, a diffusion test, a pressure hold test, a forward flow test, and the like have been employed. In particular, the bubble point test or the forward flow test utilizing the interface fracture phenomenon between gas and liquid has been used as the most convenient method, and has been reported to have a correlation with the virus removal capability.

The bubble point test is a method including wetting the porous membrane with an inspection liquid, increasing the pressure upstream of the membrane, and measuring the pressure at which bubbles started to be produced (bubble point). Since bubbles are initially produced from the largest pore existing in the membrane, the bubble point is used as the index of the largest pore. Assuming that the pore in the membrane is cylindrical, the pore size can be calculated from the bubble point using the following equation (1) (see non-patent document 1).

[Equatuin 1]
D=4Kδ×cos θ/P (1)
D: Pore size
K: Shape correction factor
δ: Surface tension of liquid
θ: Contact angle of liquid to solid
P: Gas pressure

The forward flow test is a method including wetting the porous membrane with an inspection liquid, applying a specified pressure upstream of the membrane using an appropriate gas, and measuring the flow rate of the gas permeating the wetted membrane. Since the forward flow test measures the flow rate of the gas flowing out through the pores with a pore size equal to or greater than the pore size calculated using the equation (1), the flow rate is used as the index of the large pores.

The equation (1) suggests that pore size of a membrane with a small pore size such as a virus removal membrane can be measured by increasing the gas pressure. For example, a cylindrical pore with a pore size of 50 nm can be detected at a pressure of 6.0 MPa in a method utilizing the interface fracture phenomenon between water and nitrogen. However, since the porous membrane generally cannot withstand a pressure of 4.0 MPa or more without breaking, accurate measurement cannot be performed.

The equation (1) suggests that a membrane with a small pore size can be measured by using a solution with a low interfacial tension. For example, the measurement can be performed at a pressure of 40 MPa or less if the measurement can be performed using a perfluorocarbon or the like (see patent document 3). However, since the porous membrane after filtration is wetted with water, phase separation occurs inside the membrane when using a solution with a low water solubility such as a perfluorocarbon, whereby accurate measurement cannot be performed. If the filter is wetted with a hydrophilic solvent before filtration, the measurement using a pefluorocarbon cannot be performed due to the same reason.
[Patent document 1] JP-A-7-132215
[Patent document 2] JP-A-10-235169
[Patent document 3] JP-A-5-157682
[Non-patent document 1] Bechold H, Kolloid Z., 55, 172 (1931)

### DISCLOSURE OF THE INVENTION

[Problems to be Solved by the Invention]

An objective of the present invention is to provide a method which enables gas permeation, an integrity test, and pore size measurement for a porous membrane wetted with a hydrophilic solvent to be performed at a low pressure.

[Means for Solving the Problems]

The inventor of the present invention has conducted extensive studies in order to achieve the above objective. As a result, the inventor has found that gas permeation, integrity test, and pore size measurement for a porous membrane can be performed at a low pressure by a step of causing an amphiphilic liquid or a mixture of an amphiphilic liquid and a liquid with a surface tension of 5 to 20 mN/m to permeate through a porous membrane wetted with a hydrophilic solvent, a step of causing a liquid with a surface tension of 5 to 20 mN/m to permeate through the porous membrane, a step of causing a gas to permeate through the porous membrane at a pressure of 2.5 MPa or less, and a step of measuring the flow rate or the pressure of the permeating gas. This finding has led to the completion of the present invention.

Specifically, the present invention is defined as described below.

[1] A method for causing a gas to permeate through a porous membrane having a pore size of 100 nm or less and wetted with a hydrophilic solvent at a pressure of 2.5 MPa or less, comprising:
(a) a step of causing an amphiphilic liquid or a mixture of an amphiphilic liquid and a liquid with a surface tension of 5 to 20 mN/m to permeate through the porous membrane wetted with the hydrophilic solvent;
(b) a step of causing an inspection liquid with a surface tension of 5 to 20 mN/m to permeate through the porous membrane after the step (a); and
(c) a step of causing a gas to permeate through the porous membrane at a pressure of 2.5 MPa or less after the step (b).

[1-1] The method as defined in [1], wherein the step (a) is a step of causing the amphiphilic liquid to permeate through the porous membrane wetted with the hydrophilic solvent.

[1-2] The method as defined in [1], wherein the step (a) is a step of causing the mixture of the amphiphilic liquid and the liquid with a surface tension of 5 to 20 mN/m to permeate through the porous membrane wetted with the hydrophilic solvent.

[2] The method as defined in [1], wherein the hydrophilic solvent is water or a sodium chloride solution.

[3] The method as defined in [1] or [2], wherein the amphiphilic liquid is any one of an alcohol compound, a ketone compound, an ether compound, and an ester compound.

[4] The method as defined in any of [1] to [3], wherein the alcohol compound is any one of methyl alcohol, ethyl alcohol, propanol, and isopropanol.

[5] The method as defined in any of [1] to [4], wherein the inspection liquid has compatibility with the amphiphilic liquid.

[6] The method as defined in any of [1] to [5], wherein the inspection liquid is a fluoride.

[7] The method as defined in any of [1] to [6], wherein the fluoride is any one of an ether-type fluorocarbon compound, a carbonyl-type fluorocarbon compound, an ester-type fluorocarbon compound, a COF-type fluorocarbon compound, an OF-type fluorocarbon compound, and a peroxide-type fluorocarbon compound.

[8] The method as defined in any of [1] to [7], wherein the ether-type fluorocarbon compound is a hydrofluoro ether.

[9] The method as defined in any of [1] to [8], wherein the hydrofluoro ether is C₄F₉OC₂H₅ or C₄F₉OCH₃.

[10] The method as defined in any of [1] to [9], wherein a volume percentage of the amphiphilic liquid in the mixture of the amphiphilic liquid and the liquid with a surface tension of 5 to 20 mN/m is 10 to 100 vol %.

[11] The method as defined in any of [1] to [10], wherein the gas is a gas inert to the inspection liquid and the porous membrane.

[12] The method as defined in any of [1] to [11], wherein the gas is any one of air, nitrogen, helium, argon, carbon dioxide, and hydrogen.

[13] The method as defined in any of [1] to [12], wherein the porous membrane is any one of a microfiltration membrane, an ultrafiltration membrane, and a virus removal membrane.

[14] The method as defined in any of [1] to [13], wherein the porous membrane is a polyvinylidene fluoride membrane or a polysulfone membrane.

[15] The method as defined in any of [1] to [14], wherein the pore size is 50 nm or less.

[16] The method as defined in any of [1] to [15], wherein the pressure when causing the gas to permeate through is 2.0 MPa or less.

[17] The method as defined in any of [1] to [16], wherein the porous membrane is a virus removal porous membrane; the method further comprises (d) a step of judging integrity of the porous membrane against viruses by measuring, after causing the gas to permeate through, a flow rate of the permeated gas or a pressure changed in accordance with permeation of the gas; and the gas permeation method is utilized for an integrity test method for the virus removal porous membrane.

[17-0] The method as defined in any of [1] to [17], wherein a test method in the step of judging the integrity is any one of a bubble point method, a forward flow method, a diffusion method, and a pressure hold method.

[17-1] An integrity test method for a porous membrane which includes causing a gas to permeate through the porous membrane having a pore size of 100 nm or less and wetted with a hydrophilic solvent at a pressure of 2.5 MPa or less, comprising:
(a) a step of causing an amphiphilic liquid or a mixture of an amphiphilic liquid and a liquid with a surface tension of 5 to 20 mN/m to permeate through the porous membrane wetted with the hydrophilic solvent;
(b) a step of causing an inspection liquid with a surface tension of 5 to 20 mN/m to permeate through the porous membrane after the step (a);
(c) a step of causing a gas to permeate through the porous membrane at a pressure of 2.5 MPa or less after the step (b); and
(d) a step of judging integrity of the porous membrane by measuring a flow rate of the permeated gas or a pressure changed in accordance with the permeation of the gas after the step (c).

[17-2] The integrity test method as defined in [17-1], wherein the method uses the gas permeation method as defined in any of [1] to [17] and [17-0].

[18] The integrity test method as defined in [17-1] or [17-2], wherein the test method in the step of judging the integrity is any one of a bubble point method, a forward flow method, a diffusion method, and a pressure hold method.

[19] The method as defined in any of [1] to [16], further comprising (d) a step of judging the pore size of the porous membrane by measuring, after causing the gas to permeate through, a flow rate of the permeated gas or a pressure changed by the permeation of the gas; and wherein the gas permeation method is utilized for a pore size measurement method for the porous membrane.

[19-1] A pore size measurement method for a porous membrane which includes causing a gas to permeate through the porous membrane having a pore size of 100 nm or less and wetted with a hydrophilic solvent at a pressure of 2.5 MPa or less, comprising:
(a) a step of causing an amphiphilic liquid or a mixture of an amphiphilic liquid and a liquid with a surface tension of 5 to 20 mN/m to permeate through the porous membrane wetted with the hydrophilic solvent;
(b) a step of causing an inspection liquid with a surface tension of 5 to 20 mN/m to permeate through the porous membrane after the step (a);
(c) a step of causing a gas to permeate through the porous membrane at a pressure of 2.5 MPa or less after the step (b); and
(d) a step of measuring the pore size of the porous membrane by measuring a flow rate of the permeated gas or a pressure changed in accordance with the permeation of the gas after the step (c).

[20] The pore size measurement method as defined in [19-1], using the gas permeation method as defined in any of [1] to [17] and [17-0].

The following inventions can be also given as the present invention in addition to the above inventions, although a part of the following inventions overlaps the above inventions.

(1) An integrity test method for a porous membrane wetted with a hydrophilic solvent comprising a step of causing a chemically inert inspection liquid to permeate through the porous membrane and then causing a gas to permeate through the porous membrane under pressurization, wherein the pressure is 2.5 MPa or less, and a pore size of the porous membrane is 100 nm or less.

(2) An integrity test method for a porous membrane having a pore size of 100 nm or less and wetted with a hydrophilic solvent, comprising:
(a) a step of causing an amphiphilic liquid to permeate through the porous membrane wetted with the hydrophilic solvent;
(b) a step of causing an inspection liquid with a surface tension of 5 to 20 mN/m to permeate through the porous membrane after the step (a);
(c) a step of causing a gas to permeate through the porous membrane at a pressure of 2.5 MPa or less after the step (b); and
(d) a step of testing integrity of the porous membrane by measuring a flow rate of the permeated gas or a pressure changed in accordance with the permeation of the gas after the step (c).

(3) The integrity test method as defined in (1) or (2), wherein the hydrophilic solvent is water.

(4) The integrity test method as defined in any of (1) to (3), wherein the inspection liquid is a fluoride.

(5) The integrity test method as defined in (4), wherein the fluoride is
an ether-type fluorocarbon compound, a carbonyl-type fluorocarbon compound, an ester-type fluorocarbon compound, a COF-type fluorocarbon compound, an OF-type fluorocarbon compound, or a peroxide-type fluorocarbon compound.

(6) The integrity test method as defined in (5), wherein the ether-type fluorocarbon compound is a hydrofluoro ether.

(7) The integrity test method as defined in (6), wherein the hydrofluoro ether is C₄F₉OC₂H₅ (HFE-7200) or C₄F₉OCH₃ (HFE-7100).

(8) The integrity test method as defined in any of (1) to (7), wherein the gas is air, nitrogen, helium, argon, carbon dioxide, or hydrogen.

(9) The integrity test method as defined in any of (1) to (8), wherein the porous membrane is a microfiltration membrane, an ultrafiltration membrane, or a virus removal membrane.

(10) The integrity test method as defined in any of (1) to (9), wherein the porous membrane is a polyvinylidene fluoride membrane or a polysulfone membrane.

(11) The integrity test method as defined in any of (1) to (10), wherein the pressure is 2.0 MPa or less.

(12) The integrity test method as defined in any of (1) to (11), wherein the pore size is 50 nm or less.

(13) The integrity test method as defined in any of (2) to (12), wherein the amphiphilic liquid is an alcohol compound, a ketone compound, an ether compound, or an ester compound.

(14) The integrity test method as defined in (13), wherein the alcohol compound is methyl alcohol, ethyl alcohol, propanol, or isopropanol.

(15) A pore size measurement method for a porous membrane wetted with a hydrophilic solvent, comprising a step of causing a chemically inert inspection liquid to permeate through the porous membrane and then causing a gas to permeate through the porous membrane under pressurization, wherein the pressure is 2.5 MPa or less, and a pore size of the porous membrane is 100 nm or less.

(15-2) A pore size measurement method for a porous membrane having a pore size of 100 nm or less and wetted with a hydrophilic solvent, comprising:
(a) a step of causing an amphiphilic liquid to permeate through the porous membrane wetted with the hydrophilic solvent;
(b) a step of causing an inspection liquid with a surface tension of 5 to 20 mN/m to permeate through the porous membrane after the step (a);
(c) a step of causing a gas to permeate through the porous membrane at a pressure of 2.5 MPa or less after the step (b); and
(d) a step of measuring the pore size of the porous membrane by measuring a flow rate of the permeated gas or a pressure changed in accordance with the permeation of the gas after the step (c).

(15-3) The pore size measurement method as defined in (15) or (15-2), wherein the hydrophilic solvent is water.

(15-4) The pore size measurement method as defined in any of (15) to (15-3), wherein the inspection liquid is a fluoride.

(15-5) The pore size measurement method as defined in (15-4), wherein the fluoride is an ether-type fluorocarbon compound, a carbonyl-type fluorocarbon compound, an ester-type fluorocarbon compound, a COF-type fluorocarbon compound, an OF-type fluorocarbon compound, or a peroxide-type fluorocarbon compound.

(15-6) The pore size measurement method as defined in (15-5), wherein the ether-type fluorocarbon compound is a hydrofluoro ether.

(15-7) The pore size measurement method as defined in (15-6), wherein the hydrofluoro ether is C₄F₉OC₂H₅ (HFE-7200) or C₄F₉OCH₃ (HFE-7100).

(15-8) The pore size measurement method as defined in any of (15) to (15-7), wherein the gas is air, nitrogen, helium, argon, carbon dioxide, or hydrogen.

(15-9) The pore size measurement method as defined in any of (15) to (15-8), wherein the porous membrane is a microfiltration membrane, an ultrafiltration membrane, or a virus removal membrane.

(15-10) The pore size measurement method as defined in any of (15) to (15-9), wherein the porous membrane is a polyvinylidene fluoride membrane or a polysulfone membrane.

(15-11) The pore size measurement method as defined in any of (15) to (15-10), wherein the pressure is 2.0 MPa or less.

(15-12) The pore size measurement method as defined in any of (15) to (15-11), wherein the pore size is 50 nm or less.

(15-13) The pore size measurement method as defined in any of (15-2) to (15-12), wherein the amphiphilic liquid is an alcohol compound, a ketone compound, an ether compound, or an ester compound.

(15-14) The pore size measurement method as defined in (15-13), wherein the alcohol compound is methyl alcohol, ethyl alcohol, propanol, or isopropanol.

(16) A membrane pretreatment method used for measurement of a porous membrane having a pore size of 100 nm or less and wetted with a hydrophilic solvent, comprising causing an amphiphilic liquid with a surface tension of 5 to 20 mN/m to permeate through the porous membrane before the measurement which includes causing a chemically inert inspection liquid to permeate through the porous membrane, causing a gas to permeate through the porous membrane under pressurization, and measuring a flow rate of the permeated gas or the added pressure.

[Effects of the Invention]

According to the present invention, gas permeation and pore size measurement for a porous membrane wetted with a hydrophilic solvent can be performed at a low pressure. Moreover, an integrity test capable of promptly, conveniently, and accurately predicting the virus removal capability can be performed.

### BRIEF DESCRIPTION OF THE DRAWINGS

FIG. 1 shows a measurement device used in the present invention.

FIG. 2 is a graph showing the correlation between the porcine parvovirus removal capability and the air flow rate measured using a filter with an average water permeable pore size of 17.8 to 24.3 nm.

FIG. 3 is a graph showing the correlation between the porcine parvovirus removal capability and the air flow rate measured using a filter with an average water permeable pore size of 13.9 to 18.3 nm.

### EXPLANATIONS OF NUMERALS

1 Bomb (Gas container)
2 Pressure-regulating device
3 Pressure gauge
4 Flowmeter
5 Filter
6 Nozzle cap

### BEST MODE FOR CARRYING OUT THE INVENTION

The gas permeation method, integrity test, and pore size measurement method for a porous membrane according to the present invention are described below.

It should be understood that the pore size according to the present invention refers to the maximum pore size of the porous membrane unless otherwise particularly indicated.

As examples of the hydrophilic solvent according to the present invention, water, a sodium chloride aqueous solution, a potassium chloride aqueous solution, a carbohydrate-containing aqueous solution, an alcohol compound, a ketone compound, an ether compound, an ester compound, an amine compound, and the like can be given. A preferable hydrophilic solvent is water, a sodium chloride aqueous solution, or ethanol. Of these, water or a sodium chloride aqueous solution is particularly preferable. The amphiphilic liquid is also included in the hydrophilic solvent.

As examples of the porous membrane according to the present invention, a microfiltration membrane (MF), an ultrafiltration membrane (UF), and a virus removal membrane can be given. The porous membrane is particularly suitable as a virus removal membrane.

The material for the porous membrane according to the present invention is not particularly limited insofar as the material is inert to the solution to be used. As examples of the material for the porous membrane, polyvinylidene fluoride, polysulfone, polyacrylonitrile, polycarbonate, fluorinate, and the like can be given. In addition, cellulose, cellulose acetate, and the like may also be used. Of these, polyvinylidene fluoride and polysulfone are particularly suitable. Cellulose can also be given as a suitable material. In the case where the raw material of the porous membrane is hydrophobic, the porous membrane which is subjected to a hydrophilic treatment using a known method is preferable. The effect of the present invention which allows use of a low-pressure gas reduces the risk such as injury to the worker or damage to the instrument due to a high-pressure gas. In the case where the porous membrane does not necessarily possess high strength against the high-pressure gas or liquid (specifically, the porous membrane has low elastic limit pressure), it is considered to be a particularly preferable combination. The elastic limit pressure of the porous membrane is, for example, usually 6.0 MPa or less or 4.0 MPa or less, preferably 3.0 MPa or less, still more preferably 2.5 MPa or less, particularly preferably 2.0 MPa or less, and, in some cases, preferably 1.5 MPa or less. The elastic limit pressure is usually understood to be the maximum pressure under which the structure of the porous membrane is not changed. Under the conditions equal to or greater than the elastic limit pressure, it is predicted that the membrane structure is changed or bursts with high probability.

The pore size of the porous membrane according to the present invention is not particularly limited insofar as the porous membrane has a pore size which allows the target protein to permeate through and can remove unnecessary particles such as viruses. The pore size is preferably 1 to 100 nm, and still more preferably 10 to 50 nm. The pore size is usually 1 nm or more, preferably 5 nm or more, and particularly preferably 10 nm or more. The upper limit of the pore size is not particularly limited. However the upper limit is usually 100 nm or less, preferably 70 nm or less, and particularly preferably 50 nm or less.

The shape of the porous membrane according to the present invention is not particularly limited insofar as the porous membrane can be used for filtration. For example, the porous membrane may include a hollow fiber, a flat membrane, or the like.

The amphiphilic liquid according to the present invention is not particularly limited insofar as the amphiphilic liquid is soluble in the hydrophilic solvent and the inspection liquid used for measurement. As examples of the amphiphilic liquid, an alcohol compound, a ketone compound, an ether compound, an ester compound, an amine compound, and the like can be given. The amphiphilic liquid may be a mixture of these compounds. The amphiphilic liquid may be added with other components insofar as the gas penetration method, integrity test method, and pore size measurement method for the porous membrane are not impaired. For example, water, an organic compound, or the like may be added to the amphiphilic liquid. As examples of the organic compound, pentane, hexane, and the like can be given.

The alcohol compound according to the present invention is not particularly limited insofar as the alcohol compound is any of alcohol compounds having 1 to 5 carbon atoms. As preferable alcohol compounds, methanol, ethanol, propanol, isopropanol, and the like can be given.

The ketone compound according to the present invention is not particularly limited insofar as the ketone compound is any of ketone compounds having 1 to 5 carbon atoms. As preferable ketone compounds, acetone, methyl ethyl ketone, diethyl ketone, and the like can be given.

The ether compound according to the present invention is any of ether compounds having 1 to 5 carbon atoms. As preferable ether compounds, diethyl ether, methyl ethyl ether, and the like can be given.

The ester compound according to the present invention is not particularly limited insofar as the ester compound is any of ester compounds having 1 to 5 carbon atoms. As preferable ester compounds, methyl acetate, ethyl acetate, and the like can be given.

The amine compound according to the present invention is not particularly limited insofar as the amine compound is any of amine compounds having 1 to 5 carbon atoms. As preferable amine compounds, ethylamine, dimethylamine, trimethylamine, and the like can be given.

In the case where the hydrophilic solvent is identical to the amphiphilic liquid which is caused to permeate through the porous membrane in the step (b) (in the case where both the hydrophilic solvent and the amphiphilic liquid are ethanol, for example), the inspection liquid may be caused to directly permeate through the porous membrane wetted with the hydrophilic solvent, and the step of causing the amphiphilic liquid to permeate through the porous membrane may be omitted. Or, a liquid with a surface tension of 5 to 20 mN/m or other components may be added to the amphiphilic liquid which is caused to permeate through the porous membrane in the step (b).

The inspection liquid according to the present invention is not particularly limited insofar as the inspection liquid is chemically inert and is soluble in the hydrophilic solvent or the amphiphilic liquid. It is preferable that the inspection liquid does not cause a gas as described later to be diffused to an excessive extent. As a preferable example of the inspection liquid, a fluoride can be given. As still more preferable examples of the inspection liquid, an ether-type fluorocarbon compound, a carbonyl-type fluorocarbon compound, an ester-type fluorocarbon compound, a COF-type fluorocarbon compound, an OF-type fluorocarbon compound, a peroxide-type fluorocarbon compound, and the like can be given.

As an example of the ether-type fluorocarbon compound according to the present invention, a hydrofluoro ether can be given. Specifically, C₄F₉OC₂H₅ (HFE-7200), C₄F₉OCH₃ (HFE-7100), CHF₂OCHF₂, CF₃OCHFCF₃, CHFCF₂OCH₂CF₂CHF₂, CF₃CHFCF₂CH₂OCHF₂, CF₃CHFCF₂OCH₂CF₂CF₃, CHF₂CF₂OCH₂CF₃, CF₃CHFCF₂OCH₃, CF₃CF₂CH₂OCHF₂, CF₃OCF═CF₂, C₂F₅OCF═CF₂, c-C₃F₆O, c-C₃F₆O₂, c-C₄F₈O, c-C₄F₈O₂, and the like can be given. Of these, C₄F₉OC₂H₅ (HFE-7200) and C₄F₉OCH₃ (HFE-7100) are preferable.

As examples of the carbonyl-type fluorocarbon compound according to the present invention, CF₃COCF₃ and the like can be given.

As examples of the ester-type fluorocarbon compound according to the present invention, CF₃COOCHF₂, CF₃COOC₂F₅, and the like can be given.

As examples of the COF-type fluorocarbon compound according to the present invention, CF₃COF, CF₂(COF)₂, CF₃F₇COF, COF₂, and the like can be given.

As examples of the OF-type fluorocarbon compound according to the present invention, CF₃OF and the like can be given.

As examples of the peroxide-type fluorocarbon compound according to the present invention, CF₃OOCF₃ and the like can be given.

The surface tension of the inspection liquid according to the present invention is 5 to 20 mN/m and preferably 10 to 15 mN/m. The surface tension of the inspection liquid is usually 5 mN/m or more, preferably 7 mN/m or more, and particularly preferably 10 mN/m or more. The upper limit of the surface tension of the inspection liquid is not particularly limited. However, the surface tension of the inspection liquid is usually 20 mN/m or less, preferably 17 mN/m or less, and particularly preferably 15 mN/m or less.

The volume percentage (vol %) of the amphiphilic liquid in the mixed liquid consisting of the amphiphilic liquid and the liquid with a surface tension of 5 to 20 mN/m can be calculated using the following equation (2) according to the present invention. The volume percentage is usually 10 vol % or more, preferably 20 vol % or more, and particularly preferably 30 vol % or more. The upper limit of the volume percentage is not particularly limited. However, the volume percentage is usually 100 vol % or less, preferably 90 vol % or less, and particularly preferably 80 vol % or less.

[Equation 2]
Volume percentage of amphiphilic liquid=100×Wa/(Wa+Wb) (2)
Wa: Volume of amphiphilic liquid
Wb: Volume of liquid with surface tension of 5 to 20 mN/m

The gas according to the present invention is not particularly limited insofar as the gas is inert to the inspection liquid and the porous removal membrane. As preferable examples of the gas, air, nitrogen, helium, argon, carbon dioxide, hydrogen, and the like can be given, with air, nitrogen, and helium being still more preferable.

In the present invention, the amount of the gas diffused into the inspection liquid is not particularly limited insofar as the amount of diffusion and the amount of the gas permeated through the porous membrane can be separated, and the amount of diffusion does not affect the test. The ratio of the amount of the gas diffused into the inspection liquid to the amount of the gas permeating through the porous membrane (amount of gas diffused into inspection liquid/amount of gas permeating through porous membrane) is usually 5 or less, preferably 2 or less, and still more preferably 1 or less.

As the filtration method used in the step (a) and the step (b) according to the present invention, constant pressure filtration, constant rate filtration, tangential filtration, and the like can be given.

The pressure when causing the gas to permeate through the membrane according to the present invention is preferably equal to or lower than the elasticity limit pressure of the membrane, and still more preferably 2.5 MPa or less. The pressure is preferably 2.0 MPa or less, and still more preferably 1.5 MPa or less when taking the risk of the operation and the equipment into consideration.

The filtration pressure in the step (a) and the step (b) according to the present invention is not particularly limited insofar as the structure of the porous membrane is not affected. However, the filtration pressure is preferably 1.0 MPa or less, still more preferably 0.5 MPa or less, and particularly preferably 0.3 MPa or less.

The filtration temperature in the step (a) and the step (b) according to the present invention is not particularly limited insofar as the structure of the porous membrane and the properties of the amphiphilic liquid and the inspection liquid are not affected. However, the filtration temperature is preferably 4 to 35° C., and still more preferably 15 to 25° C. The filtration temperature is usually 4° C. or more, preferably 10° C. or more, and particularly preferably 15° C. or more. The upper limit of the filtration temperature is not particularly limited. However, the filtration temperature is usually 35° C. or less, preferably 30° C. or less, and particularly preferably 25° C. or less.

The method for removing the hydrophilic solvent, the amphiphilic liquid or the mixture of the amphiphilic liquid and the liquid with a surface tension of 5 to 20 mN/m, and the inspection liquid with a surface tension of 5 to 20 mN/m remaining inside the filter before and after carrying out each step according to the present invention is not particularly limited insofar as the membrane structure is not affected. For example, a method of causing a gas such as air or nitrogen to flow through the membrane at a certain pressure to remove the liquid remaining inside the membrane can be given. In the step (a), it is preferable to use the amphiphilic liquid. However, it is also preferable to use a mixture of the amphiphilic liquid and a liquid with a surface tension of 5 to 20 mN/m. In the case of using the amphiphilic liquid in the step (a), it is preferable to carry out the removal operation using gas at the end of the step (a). In the case of using a mixture of the amphiphilic liquid and a liquid with a surface tension of 5 to 20 mN/m in the step (a), it is not necessarily required to carry out the removal operation using gas at the end of the step (a), whereby the operation is simplified. Moreover, since the filtration rate is higher when using the mixture of the amphiphilic liquid and the liquid with a surface tension of 5 to 20 mN/m in comparison with the filtration rate of the amphiphilic liquid, and the replacement of the solution inside the porous membrane can be efficiently performed, it is preferable to use the mixture of the amphiphilic liquid and the liquid with a surface tension of 5 to 20 mN/m.

The amount of filtration in the step (a) according to the present invention is 0.1 L/m² or more, preferably 1 L/m² or more, still more preferably 5 L/m² or more, and particularly preferably 10 L/m² or more. The unit L/m² indicates the amount of filtration per effective area of the porous membrane.

The amount of filtration in the step (b) according to the present invention is 5 μm² or more, preferably 10 L/m² or more, and particularly preferably 20 L/m² or more.

The pressure used in the step (c) according to the present invention is preferably equal to or less than the elasticity limit pressure of the membrane. The pressure is preferably 2.5 MPa or less. Taking the risk of the operation and the equipment into consideration, the pressure is preferably 2.0 MPa or less, and particularly preferably 1.5 MPa or less.

The measurement temperature in the step (c) and the step (d) according to the present invention is not particularly limited insofar as the measurement is not affected. However, the measurement temperature is usually 4° C. or more, preferably 10° C. or more, and particularly preferably 15° C. or more. The upper limit of the measurement temperature is not particularly limited. However, the measurement temperature is usually 35° C. or less, preferably 30° C. or less, and particularly preferably 25° C. or less.

The gas permeation method according to the present invention may be used for an integrity test for a porous membrane having a maximum pore size of 100 nm or less and wetted with a hydrophilic solvent. The gas permeation method according to the present invention may also be used for a maximum pore size measurement method for a porous membrane having a maximum pore size of 100 nm or less and wetted with a hydrophilic solvent. The gas permeation method according to the present invention may also be used for an average flow rate pore size measurement method for a porous membrane having a maximum pore size of 100 nm or less and wetted with a hydrophilic solvent. The gas permeation method according to the present invention may also be used for a pore size distribution measurement method for a porous membrane with a maximum pore size of 100 nm or less.

The integrity test method according to the present invention is a method for confirming a change in the pore size of the porous membrane. The virus removal method using the porous membrane is a method including filtering a virus-containing liquid through a porous membrane having pores with a pore size smaller than the size of the virus, and capturing the virus with the pore to remove. Therefore, a change in the pore size or pore size distribution of the porous membrane affects the virus removal capability. In particular, the virus removal capability is affected by a change in the large pores in the porous membrane. Therefore, a method which enables to confirm the change in the pore size of the porous membrane as the index of the virus removal capability is preferable. The method is not particularly limited insofar as the method utilizes the gas-liquid interface. For example, a bubble point method, a forward flow method, a diffusion method, a pressure hold method, and the like can be given.

As an example of the bubble point method according to the present invention, the following method can be given. Specifically, after wetting the porous membrane with an inspection liquid, an appropriate gas is caused to flow from upstream of the porous membrane, and the pressure is gradually increased. When the pressure has reached a certain pressure, bubbles are produced from downstream of the porous membrane. This pressure is called a bubble point. Assuming that the pore in the membrane is cylindrical, the maximum pore size can be calculated by substituting the bubble point pressure value into the equation (3) as described later. Therefore, the bubble point method is considered to be the index of a change in the maximum pore size. In more detail, the porous membrane is wetted with an inspection liquid such as C₄F₉OC₂H₅ (HFE-7200, surface tension: 13.6 mN/m), and the pressure at upstream of the porous membrane is gradually increased using a gas such as air. The gas permeates through the porous membrane when the pressure has reached a certain pressure, whereby bubbles are produced from downstream of the porous membrane. If this pressure (bubble point) is 1 MPa, for example, the maximum pore size is calculated to be 38.9 nm using the equation (3). A change in the maximum pore size affects the virus removal capability of the virus removal membrane. Specifically, the virus removal capability of the virus removal membrane can be controlled by controlling the maximum pore size. If the maximum pore size is the same, it is judged that the virus removal capability of the virus removal membrane has not been changed. Therefore, the bubble point method may be used as the management method for manufacturing the porous membrane and as a method for confirming whether or not an abnormality has occurred in the porous membrane before and after use of the porous membrane.

As an example of the forward flow test according to the present invention, a method comprising wetting the porous membrane with an inspection liquid, applying a specific pressure to upstream of the porous membrane using an appropriate gas, and measuring the flow rate of the gas flowing through the wetted membrane can be given. Since the measurement pressure is usually equal to or higher than the bubble point, this method allows measurement of the flow rate of the gas permeating through the pore with a pore size greater than the pore size corresponding to the measurement pressure. Therefore, if the forward flow method is used in the step (d), the forward flow method is used as the index of a change in the large pores. In more detail, the porous membrane is wetted with an inspection liquid such as C₄F₉OC₂H₅ (HFE-7200, surface tension: 13.6 mN/m), and gas is caused to flow at a certain pressure such as 1.2 M P a for example. In this case, the gas permeates through the pore with a pore size of 32.4 nm or more of the porous membrane as calculated from the equation (3). In the case where the porous membrane is a virus removal membrane, a change in the large pores affects the virus removal capability of the virus removal membrane. Specifically, the virus removal capability of the virus removal membrane can be controlled by controlling the flow rate. If the flow rate is the same, it is judged that the large pore in the porous membrane has not been changed and that the virus removal capability of the virus removal membrane has not been changed. Therefore, the forward flow method can be used as the porous membrane manufacturing management method and as a method for confirming whether or not an abnormality has occurred in the porous membrane before and after use of the porous membrane. An instrument used to measure the flow rate of the porous membrane in the forward flow method is not particularly limited insofar as the instrument can accurately measure the flow rate. For example, a purge flow meter, a mass flow meter, a vortex flow meter, or the like may be used.

The diffusion method according to the present invention is a method comprising wetting the membrane with an inspection liquid, increasing the pressure in upstream of the membrane to a constant pressure equal to or lower than the bubble point using an appropriate gas, and measuring the flow rate of the gas diffused downstream through the wetted membrane. Diffusion occurs at the interface between the inspection liquid and the gas inside the pore, and the diffusion amount changes depending on the area of the interface. Specifically, the area of the interface is changed when the pore size is changed, whereby the diffusion amount is changed. Therefore, the diffusion method is used as the index of a change in the pore size. In more detail, the porous membrane is wetted with an inspection liquid such as C₄F₉OC₂H₅ (HFE-7200, surface tension: 13.6 mN/m), and gas is caused to flow at a certain pressure, for example 0.3 MPa. In this case, the gas permeates only through the pores with a pore size of 130 nm or more as calculated from the equation (3), and does not permeate through the pores with a maximum pore size of 100 nm or more of the porous membrane. However, the interface between HFE-7200 and air exists inside the porous membrane, and air is diffused into HFE-7200 from the interface. The diffusion amount correlates to the area of the total pores of the porous membrane, and the diffusion amount is changed when the pore size distribution is changed. In the case where the porous membrane is a virus removal membrane, a change in the pore size distribution affects the virus removal capability of the virus removal membrane. Specifically, the virus removal capability of the virus removal membrane can be controlled by controlling the diffusion amount. If the diffusion amount is the same, it is judged that the pore size distribution of the porous membrane has not been changed and that the virus removal capability of the virus removal membrane has not been changed. Therefore, the diffusion method may be used as the method for managing the manufacture of porous membrane and as a method for confirming whether or not an abnormality has occurred in the porous membrane before and after use of the porous membrane. An instrument used to measure the diffusion amount of the porous membrane in the diffusion method is not particularly limited insofar as the instrument can accurately measure the diffusion amount. For example, a purge flow meter, a mass flow meter, a vortex flow meter, or the like may be used.

The pressure hold method according to the present invention is a method comprising wetting the membrane with an inspection liquid, increasing the pressure in upstream of the membrane to a constant pressure equal to or higher than the bubble point using an appropriate gas, stopping pressurization of the gas, and measuring a change in the pressure within a predetermined period of time. The change in the pressure correlates to the amount of gas permeating through the pore with a pore size equal to or greater than the pore size corresponding to the measurement pressure. Therefore, the pressure hold method is used as the index of a change in the large pores as well as the forward flow method. In more detail, the porous membrane is wetted with an inspection liquid such as C₄F₉OC₂H₅ (HFE-7200, surface tension: 13.6 mN/m), and gas is caused to flow through at a certain pressure, for example 1.2 MPa. In this case, the gas permeates through the pores with a pore size of 32.4 nm or more of the porous membrane as calculated from the equation (3). When the pressure supply is then stopped, the pressure is decreased corresponding to the amount of the gas permeated. If the internal pressure after a certain period of time has elapsed is 1.0 MPa, for example, the change in the pressure is 0.2 MPa, and correlates to the flow rate of the gas permeating through the porous membrane. In the case where the porous membrane is a virus removal membrane, a change in the large pores affects the virus removal capability of the virus removal membrane. Specifically, the virus removal capability of the virus removal membrane can be controlled by controlling a change in the pressure. If the change in the pressure is the same, it is judged that the large pores in the porous membrane have not been changed and that the virus removal capability of the virus removal membrane has not been changed. Therefore, the pressure hold method may be used as the method for managing the manufacture of porous membrane and as a method for confirming whether or not an abnormality has occurred in the porous membrane during use by carrying out the pressure hold method before and after use of the porous membrane. An instrument used for measuring the pressure of the porous membrane by the pressure hold method is not particularly limited insofar as the instrument can accurately measure the pressure. For example, a pressure gauge, a differential pressure gauge, or the like may be used.

The integrity test method according to the present invention is used for a porous membrane wetted with a hydrophilic solvent, and may be utilized anytime regardless before or after filtration. In the case of using the integrity test method after filtration, the integrity test method may be used after filtering proteins using the porous membrane and washing the proteins remaining in the membrane, for example.

The washing is not particularly limited insofar as the washing method does not affect the membrane, and can remove the substance adhered on and captured by the porous membrane during protein filtration. As a conventional method, a method of filtering a washing solution such as a protein removing agent containing an alkali, surfactant, and the like (as disclosed in JP-A-H09-141068, for example), and rinsing the washing solution with water, or the like can be given. As the method for washing the porous membrane, a method causing the washing solution to flow in the protein filtration direction (forward washing), a method causing to flow in the direction opposite to the protein filtration direction (reverse washing), or a method of washing by causing the membrane to come in contact with the washing solution (immersion washing) may be given.

As the substance adhered on and captured by the porous membrane according to the present invention, a protein, lipid, carbohydrate, nucleic acid, and the like can be given. As the protein, an enzyme, antibody, blood coagulation factor, cytokine such as an interleukin and erythropoietin, and the like can be given. As the lipid, a long-chain fatty acid, phospholipid, and the like can be given. As the nucleic acid, DNA, RNA, and the like can be given. In particular, the porous membrane is effective for proteins such as globulin and albumin.

The maximum pore size measurement method, the average flow rate pore size measurement method, and the pore size distribution measurement method according to the present invention are carried out according to the method and the equation described in ASTM F316-86. The maximum pore size measurement method of the present invention is carried out using the same method as that of the bubble point method. The calculation is carried out using the following equation (3).

[Equation 3]
D=2.86×δ/P (3)
D: Maximum pore size (nmn)
δ: Surface tension of liquid (mN/m)
P: Gas pressure (MPa)

The average flow rate pore size used in the present invention refers to the pore size calculated from the flow rate of the gas permeated by gradually increasing the pressure to the dried porous membrane and the porous membrane wetted with the inspection liquid. The measurement method is carried out according to the method and the equation described in ASTM F316-86. In more detail, air is caused to flow through the dried porous membrane, and the pressure is gradually increased to measure the flow rate. A correlation line 1 between the pressure and the ½ flow rate is created from the results. Then, the porous membrane is wetted with the inspection liquid, and the pressure is gradually increased using air to measure the flow rate. A correlation line 2 between the pressure and the flow rate is created from the results. The average flow rate pore size can be calculated by determining the pressure at which the correlation line 1 and the correlation line 2 intersect, and then substituting the pressure value into the equation (3).

The pore size distribution used in the present invention refers to the distribution of the pore size and the percentage of the flow rate of the gas permeating through the pores with each pore size. The measurement method is carried out according to the method and the equation described in ASTM F316-86. In more detail, a desired pore size range is set. For example, the pore size range is set at 20 to 21 nm. A pressure 1 (20 nm) and a pressure 2 (21 nm) corresponding to 20 nm and 21 nm are calculated using the equation (3). Then, air is caused to flow through the dried porous membrane, and the pressure is set at the pressure 1 and the pressure 2 to measure the flow rate. The porous membrane is wetted with the inspection liquid, air is caused to flow through the porous membrane, and the pressure is set at the pressure 1 and the pressure 2 to measure the flow rate. The resulting values are substituted into the following equation (4) to calculate the ratio of the flow rate of the gas permeated the pores with a pore size of 20 to 21 nm to the flow rate of the gas permeating the filter. This step is repeatedly performed to determine the relationship between the pore size and the percentage of the flow rate of the gas permeated the pores with each pore size.

[Equation 4]
R=(WH/DH−WL/DL)×100 (4)
R: Ratio (%) of flow rate of gas permeated pores with pore sizes corresponding to low pressure and high pressure to flow rate of gas permeated filter
WH: High-pressure wet flow rate
DH: High-pressure dry flow rate
WL: Low-pressure wet flow rate
DL: Low-pressure dry flow rate

The average water permeable pore size used in the present invention refers to the pore size determined by causing water to permeate through the porous membrane at a certain pressure, and calculating the pore size from the water permeation rate. The calculation was carried out using the following equation (5).

[Equation 5]
PS=15×(V×t×μ/P/Aα)^{0.4} (5)
PS: Average water permeable pore size (nm)
V: Water permeation amount (mL/min)
t: Membrane thickness (μm)
μ: Viscosity coefficient of water (cP)
P: Filtration pressure (kPa)
A: Membrane area (m²)
α: Porosity (%)

The outer diameter and the inner diameter of the hollow fiber porous membrane of the present invention were determined by photographing the vertical cross section of the membrane at a magnification of 210 using a stereoscopic microscope (“Scopeman 503” manufactured by Moritex). The thickness of the membrane was calculated as ½ of the difference between the outer diameter and the inner diameter of the hollow fiber.

The porosity of the porous membrane of the present invention was calculated from the values obtained by measuring the volume and the mass of the porous membrane using the following equation (6).

[Equation 6]
Porosity (%)=(1−mass÷(density of resin×volume))×100 (6)

The water permeation amount of the porous membrane of the present invention was calculated by measuring the permeated amount of pure water at 25° C. by constant pressure filtration, and using the following equation (7) with the values of the membrane area, filtration pressure (0.1 MPa), and filtration time.
[Equation 7]

$$Water permeation amount ( {m}^{3} \text{/} {m}^{2} \text{/} sec \text{/} Pa ) = permeated amount \div ( membrane area \times differential pressure \times filtration time ) \qquad ( 7 )$$

The calculation of the virus removal capability according to the present invention was carried out using the following equation (8).

[Equation 8]
Φ=log(No/Nf) (8)
Φ: Virus removal capability
No: Virus concentration in unfiltered liquid
Nf: Virus concentration in filtrate

### EXAMPLES

The present invention is described below by examples, comparative examples, and test examples. However, the present invention should not be construed as being limited to these examples.

### Test Example 1

A PVDF porous hollow fiber membrane with an average water permeable pore size of 24.3 nm (maximum pore size measured in Test Example 2 as described below was 40.9 nm) was manufactured according to the method disclosed in International Publication WO 2004/035180 (International application number: PCT/JP03/01332), and was formed into a filter A with a membrane area of 0.1 m². The method of manufacturing the filter A disclosed in International Publication WO 2004/035180 is as follows.

A composition containing 49 wt % of a polyvinylidene fluoride resin (“Sofef 1012” manufactured by Solvay, crystal melting point: 173° C.) and 51 wt % of dicyclohexyl phthalate (manufactured by Osaka Organic Chemical Industry Co., Ltd. Industrial product) was mixed and stirred at 70° C. using a Henschel mixer, and was cooled to obtain a powdered product. The resulting product was placed in a twin-screw extruder (“Labo Plastomill Model 50C 150” manufactured by Toyo Selki Seisaku-Sho, Ltd.) from a hopper, and was uniformly dissolved by melting and mixing the product at 210° C. The dissolved product was extruded in the shape of a hollow fiber from a spinning nozzle formed of a ring orifice with an inner diameter of 0.8 mm and an outer diameter of 1.1 mm at an extruding rate of 17 m/min while causing dibutyl phthalate (manufactured by Sanken Kako Co., Ltd.) at 130° C. to flow inside the hollow fiber at a rate of 8 mL/min. The extruded product was cooled and solidified in a water bath maintained at 40° C., and was wound at a rate of 60 m/min. After removing dicyclohexyl phthalate and dibutyl phthalate by extraction with 99% methanol-modified ethanol (manufactured by Imazu Chemical Co., Ltd. Industrial product), the adhering ethanol was replaced with water. The resulting product was subjected to a heat treatment at 125° C. for one hour using a high-pressure steam sterilizer (“HV-85” manufactured by Hirayama Manufacturing Corporation) in a state in which the product was immersed in water. After replacing the adhering water with ethanol, the resulting product was dried at 60° C. in an oven to obtain a hollow fiber porous membrane. In the steps from extraction to drying, the treatment was performed while securing the membrane in a constant length state in order to prevent occurrence of shrinkage.

The porous membrane was then subjected to a hydrophilic treatment using a grafting method. As the reaction liquid, a liquid obtained by dissolving hydroxypropyl acrylate (manufactured by Tokyo Kasei Kogyo Co., Ltd. Reagent grade) in a 25 vol % aqueous solution of 3-butanol (manufactured by Junsei Kagaku Co., Ltd. Special grade reagent) so that the hydroxypropyl acrylate content was 8 vol %, and bubbling nitrogen for 20 min while holding at 40° C. was used. The porous membrane was irradiated with y-rays at 100 kGy from Co⁶⁰ as the irradiation source under a nitrogen atmosphere while cooling the porous membrane to −60° C. with dry ice. The membrane after irradiation was allowed to stand under a reduced pressure of 13.4 Pa or less for 15 min, caused to come in contact with the above reaction liquid, and allowed to stand for one hour. After washing the membrane with ethanol, the membrane was dried at 60° C. for four hours under vacuum to obtain a porous membrane. It was confirmed that water spontaneously permeated into the pores when causing the obtained membrane to come in contact with water and that the membrane exhibited excellent performance.

15 ml of HFE-7200 (surface tension δ=13.6 mN/m) was caused to permeate through the dried filter A at 0.196 MPa to fill the filter with HFE-7200. The filter A was connected with a flow meter and the air pressure was slowly increased to 1.00 MPa to measure the flow rate of air permeated through the filter A (indicated as “flow rate 1” in Table 1). The results are shown in Table 1.

### Example 1

5 ml of water was caused to permeate through the filter A at 0.294 MPa to prepare a filter B wetted with water. After removing the water from the nozzle of the filter B, 1 ml of isopropanol (hereinafter may be abbreviated as “IPA”) was caused to permeate through the filter B at 0.294 MPa. After removing the IPA from the filter B, the filter B was dried for five minutes using air under 0.098 MPa. Then, 10 ml of HFE was caused to permeate through the filter B at 0.196 MPa to fill the filter B with HFE-7200. After removing the HFE-7200 in the filter, 10 ml of HFE-7200 was again caused to permeate through the filter B under 0.196 MPa to fill the filter B with HFE-7200. The resulting filter B was connected with a flow meter, and the air pressure was slowly increased to 1.00 MPa to measure the flow rate of the permeated air (indicated as “flow rate 2” in Table 1; hereinafter the same). As is clear from the results shown in Table 1, even the filter wetted with water could be caused the gas to permeate through at a low pressure by replacing the liquid in the filter with IPA and HFE-7200 in that order and causing the gas to permeate through. It was also found that the forward flow rate can be measured as well as the filter A which was not wetted with water.

### Example 2

5 ml of water was caused to permeate through the filter A at 0.294 MPa to prepare the filter B wetted with water. After removing the water from the nozzle of the filter B, 10 ml of an IPA/HFE-7200 (30/70 vol %) liquid was caused to permeate through the filter B at 0.294 MPa to fill the filter with the IPA/HFE-7200 liquid. After removing the IPA/HFE-7200 liquid from the filter B, 3 ml of the IPA-HFE-7200 liquid was again caused to permeate through the filter B at 0.294 MPa. After removing the IPA/HFE-7200 liquid from the nozzle of the filter B, 10 ml of HFE-7200 was caused to permeate through the filter B at 0.196 MPa to fill the filter with HFE-7200. After removing the HFE-7200 from the filter, 10 ml of HFE-7200 was again caused to permeate through the filter at 0.196 MPa to fill the filter with HFE-7200. The filter B was connected with a flow meter, and the air pressure was slowly increased to 1.00 MPa to measure the flow rate of permeated air.

As is clear from the results shown in Table 1, the gas could be caused to permeate through the filter wetted with water at a low pressure by replacing the liquid inside the filter with the IPA/HFE-7200 mixture and HFE-7200 in that order and causing the gas to permeate through. It was also found that the forward flow rate can be measured as well as the filter A which was not wetted with water. As described above, in the case of using a mixture of the amphiphilic liquid and the liquid with a surface tension of 5 to 20 mN/m, the filter wetted with water can be measured without drying the filter by causing a gas to permeate at a certain pressure. When subjected to filtration at 0.294 Pa and 25° C., the filtration rate of IPA was 0.08 L/min/m², and the filtration rate of the IPA/HFE-7200 (30/70 vol %) liquid was 3.30 L/min/m². This shows that the liquid inside the filter could be efficiently replaced in a short period of time.

### Example 3

A forward flow rate was measured by using the same method as in Example 1 except for using a filter C in which a PVDF porous hollow fiber membrane prepared in the same manner as described above had an average water permeable pore size of 18.5 nm (maximum pore size measured in Example 14 was 35.5 nm) and a filter D obtained by wetting the filter C with water and carrying out under the measurement pressure of 1.18 MPa. The filter C was manufactured basically according to the same manufacturing method as that for the filter A except for appropriately changing the resin composition concentration in order to control the pore size.

As is clear from the results shown in Table 1, the gas could be caused to permeate through the filter with an average water permeable pore size of 18.5 nm at a low pressure by replacing the liquid inside the filter with IPA and HFE-7200 in that order and causing the gas to permeate. It was also found that the forward flow rate can be measured as well as the filter C which was not wetted with water.

### Example 4

A forward flow rate was measured by using the same method as in Example 2 except for using the filter C and the filter D obtained by wetting the filter C with water and changing the measurement pressure to 1.18 MPa. As is clear from the results shown in Table 1, the gas could be caused to permeate through the filter with an average water permeable pore size of 18.5 nm at a low pressure by replacing the liquid inside the filter with the IPA/HFE-7200 mixture and HFE-7200 in that order and causing the gas to permeate through. It was also found that the forward flow rate can be measured as well as the filter C which was not wetted with water.

### Example 5

The measurement was conducted in the same manner as in Example 2 except for changing the mixture of the amphiphilic liquid and the liquid with a surface tension of 5 to 20 mN/m from the IPA/HFE-7200 (30/70 vol %) liquid to an IPA/HFE-7200 (10/90 vol %) liquid. As is clear from the results shown in Table 1, it was found that the forward flow rate can also be measured using the IPA/HFE-7200 (10/90 vol %) liquid as the mixture of the amphiphilic liquid and the liquid with a surface tension of 5 to 20 mN/m.

### Example 6

The measurement was conducted in the same manner as in Example 2 except for changing the hydrophilic solvent from water to a sodium chloride aqueous solution. As is clear from the results shown in Table 1, it was found that the forward flow rate can also be measured using the sodium chloride aqueous solution as the hydrophilic solvent.

### Example 7

The measurement was conducted in the same manner as in Example 2 except for changing the amphiphilic liquid from IPA to ethanol. As is clear from the results shown in Table 1, it was found that the forward flow rate can also be measured using ethanol as the amphiphilic liquid.

### Example 8

The measurement was conducted in the same manner as in Example 2 except for changing the inspection liquid from HFE-7200 to HFE-7100 (surface tension δ=13.6 mN/m). As is clear from the results shown in Table 1, it was found that the forward flow rate can also be measured using HFE-7100 as the inspection liquid.

### Example 9

The measurement was conducted in the same manner as in Example 2 except for changing the gas from air to nitrogen. As is clear from the results shown in Table 1, it was found that the forward flow rate can also be measured using nitrogen as the gas.

### Example 10

A PVDF porous hollow fiber membrane with an average water permeable pore size of 16.6 nm (maximum pore size measured in Example 21 was 30.4 nm) was manufactured in the same manner as described above, and was formed into a filter E with a membrane area of 0.1 m².

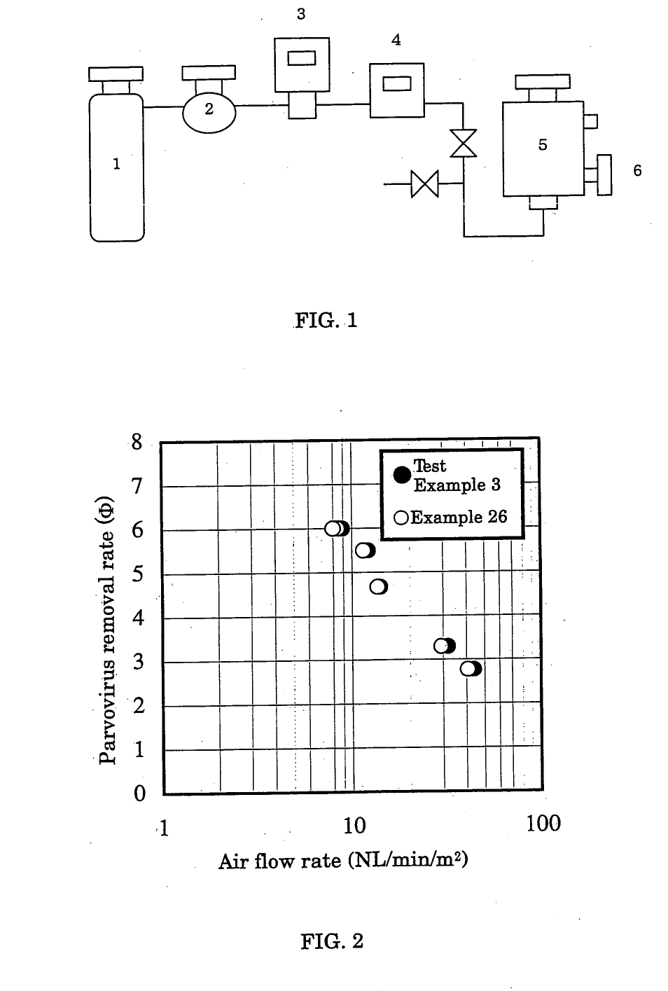

500 ml of HFE-7200 was caused to permeate through the dried filter E at 0.098 MPa to fill the filter with HFE-7200. The filter was then connected with the device shown in FIG. 1. The air pressure was set at 1.2 MPa, and the flow rate of the permeated air was measured using a flow meter 4.

50 ml of water was caused to permeate through the filter E at 0.196 MPa to prepare a filter F wetted with water. After removing the water from the nozzle of the filter, 5 ml of ethanol was filtered at 1.96 kPa. After drying the filter for five minutes using air at 0.098 MPa, 20 ml of ethanol was filtered. After removing the ethanol from the nozzle of the filter E, the filter was dried for five minutes using air at 0.098 MPa. 500 ml of HFE-7200 was then filtered to fill the filter with HFE-7200. The filter was then connected with the device shown in FIG. 1, and the air pressure was set at 1.2 MPa to measure the flow rate of the permeated air. As is clear from the results shown in Table 1, it was found that a change in the large pores can be confirmed by replacing the liquid inside the filter F wetted with water with ethanol and HFE-7200 in that order and causing the gas to permeate through as well as the filter E which was not wetted with water.

### Example 11

The measurement was conducted in the same manner as in Example 10 except for using a filter G prepared in the same manner as described above and having an average water permeable pore size of 13.9 nm (maximum pore size measured in after-mentioned Example 22 was 28.5 nm) and a filter H obtained by wetting the filter G with water. As is clear from the results shown in Table 1, it was found that a change in the large pores can be confirmed by replacing the liquid inside the filter H wetted with water with ethanol and HFE-7200 in that order and causing the gas to permeate as well as the filter G which was not wetted with water.

[Table 1]

TABLE 1

| | Example 1 | Example 2 | Example 3 | Example 4 | Example 5 | Example 6 | Example 7 | Example 8 |
|---|---|---|---|---|---|---|---|---|
| Filter type | A, B | A, B | C, D | C, D | A, B | A, B | A, B | A, B |
| Hydrophilic solvent | Water | Water | Water | Water | Water | Sodium | Water | Water |
| | | | | | | chloride | | |
| Amphiphilic liquid | IPA | 30 vol % IPA/ | IPA | 30 vol % IPA/ | 10 vol % IPA/ | 10 vol % IPA/ | EtOH | 30 vol % IPA/ |
| | | 70 vol % HFE- | | 70 vol % HFE- | 90 vol % HFE- | 90 vol % HFE- | | 70 vol % HFE- |
| | | 7200 | | 7200 | 7200 | 7200 | | 7200 |
| Inspection liquid | HFE-7200 | HFE-7200 | HFE-7200 | HFE-7200 | HFE-7200 | HFE-7200 | HFE-7200 | HFE-7100 |
| Surface tension | 13.6 | 13.6 | 13.6 | 13.6 | 13.6 | 13.6 | 13.6 | 13.6 |
| (mN/m) | | | | | | | | |
| Gas | Air | Air | Air | Air | Air | Air | Air | Air |
| Flow rate 1 | 11.1 | 11.1 | 7.00 | 7.00 | 11.1 | 11.1 | 11.1 | 11.3 |
| (NL/min./m²) | | | | | | | | |
| Flow rate 2 | 11.4 | 10.8 | 6.86 | 6.78 | 10.3 | 10.7 | 10.8 | 10.9 |
| (NL/min./m²) | | | | | | | | |
| | | | | Comparative | Comparative | Comparative | Comparative | Comparative |
| | Example 9 | Example 10 | Example 11 | Example 1 | Example 2 | Example 3 | Example 4 | Example 5 |
| Filter type | A, B | E, F | G, H | A, B | A, B | A, B | E, F | E, F |
| Hydrophilic solvent | Water | Water | Water | Water | Water | Water | Water | Water |
| Amphiphilic liquid | 30 vol % IPA/ | EtOH | EtOH | — | 7 vol % IPA/ | 30 vol % IPA/ | — | EtOH |
| | 70 vol % HFE- | | | | 93 vol % HFE- | 70 vol % HFE- | | |
| | 7200 | | | | 7200 | 7200 | | |
| Inspection liquid | HFE-7200 | HFE-7200 | HFE-7200 | HFE-7200 | HFE-7200 | 30% IPA | HFE-7200 | 30% IPA |
| Surface tension | 13.6 | 13.6 | 13.6 | 13.6 | 13.6 | 13.6 | 13.6 | 13.6 |
| (mN/m) | | | | | | | | |
| Gas | Nitrogen | Air | Air | Air | Air | Air | Air | Air |
| Flow rate 1 | 11.5 | 11.5 | 2.20 | 11.1 | 11.1 | 11.1 | 1.15 | 1.15 |
| (NL/min./m²) | | | | | | | | |
| Flow rate 2 | 11.3 | 11.3 | 2.30 | Did not | Did not | Did not | Did not | Did not |
| (NL/min./m²) | | | | permeate | permeate | permeate | permeate | permeate |

Flow rate 1: Flow rate measured when causing gas to permeate through dried filter
Flow rate 2: Flow rate measured when causing gas to permeate through filter wetted with hydrophilic solvent

### Test Example 2

15 ml of HFE-7200 (δ=13.6 mN/m) was caused to permeate through the dried filter A at 0.196 MPa to fill the filter with HFE-7200. The filter A was connected with a flow meter, and the air pressure was slowly increased to measure the pressure at which bubbles started to be produced (indicated as “pressure 1” in Table 2). The results are shown in Table 2.

### Example 12

5 ml of water was caused to permeate through the filter A at 0.294 MPa to prepare the filter B wetted with water. After removing the water from the nozzle of the filter B, 1 ml of IPA was caused to permeate through at 0.294 MPa. After removing the IPA from the filter B, the filter B was dried for five minutes using air at 0.098 MPa. 10 ml of HFE was caused to permeate through at 0.196 MPa to fill the filter with HFE. After removing the HFE from the filter, 10 ml of HFE was again caused to permeate through at 0.196 MPa to fill the filter with HFE. The filter B was connected with a flow meter, and the air pressure was slowly increased and the pressure at which bubbles started to be produced was measured (indicated as “pressure 2” in Table 2; hereinafter the same). As is clear from the results shown in Table 2, it was found that the maximum pore size can be measured by replacing the liquid inside the filter wetted with water with IPA and HFE in that order as well as the filter A which was not wetted with water.

### Example 13

5 ml of water was caused to permeate through the filter A at 0.294 MPa to prepare the filter B wetted with water. After removing the water from the nozzle of the filter B, 10 ml of an IPA/HFE (30/70 vol %) liquid was caused to permeate at 0.294 MPa to fill the filter with the IPA/HFE liquid. After removing the IPA/HFE liquid from the filter B, 3 ml of the IPA/HFE liquid was again caused to permeate at 0.294 MPa. After removing the IPA/HFE liquid from the nozzle of the filter B, 10 ml of HFE was caused to permeate at 0.196 MPa to fill the filter with HFE. After removing the HFE from the filter, 10 ml of HFE was again caused to permeate at 0.196 MPa to fill the filter with HFE. The filter B was connected with a flow meter, and the air pressure was slowly increased, and the pressure at which bubbles started to be produced was measured. As is clear from the results shown in Table 2, it was found that the maximum pore size can be measured by replacing the liquid inside the filter wetted with water with the IPA/HFE mixture and HFE in that order and causing the gas to permeate as well as the filter A which was not wetted with water.

### Example 14

The maximum pore size was measured by using the same method as in Example 12 except for using the filter C comprising a PVDF porous hollow fiber membrane having an average water permeable pore size of 18.5 nm (maximum pore size measured in Example 14 as described later was 35.5 nm) and the filter D obtained by wetting the filter C with water. As is clear from the results shown in Table 2, it was found that the maximum pore size can be measured in the same manner by replacing the liquid inside the filter wetted with water with IPA and HFE in that order and causing the gas to permeate through as well as the filter A which was not wetted with water.

### Example 15

The maximum pore size was measured by using the same method as in Example 13 except for using the filter C and the filter D obtained by wetting the filter C with water. As is clear from the results shown in Table 2, it was found that the maximum pore size can be measured by replacing the liquid inside the filter wetted with water with the IPA/HFE mixture and HFE in that order and causing the gas to permeate through as well as the filter A which was not wetted with water.

### Example 16

The measurement was conducted in the same manner as in Example 13 except for changing the mixture of the amphiphilic liquid and the liquid with a surface tension of 5 to 20 mN/m from the IPA/HFE-7200 (30/70 vol %) liquid to an IPA/HFE-7200 (10/90 vol %) liquid. As is clear from the results shown in Table 2, it was found that the maximum pore size can also be measured using the IPA/HFE-7200 (70/30 vol %) liquid as the mixture of the amphiphilic liquid and the liquid with a surface tension of 5 to 20 mN/m.

### Example 17

The measurement was conducted in the same manner as in Example 13 except for changing the hydrophilic solvent from water to a sodium chloride aqueous solution. As is clear from the results shown in Table 2, it was found that the maximum pore size can also be measured using the sodium chloride aqueous solution as the hydrophilic solvent.

### Example 18

The measurement was conducted in the same manner as in Example 13 except for changing the amphiphilic liquid from IPA to ethanol. As is clear from the results shown in Table 2, it was found that the maximum pore size can also be measured using ethanol as the amphiphilic liquid.

### Example 19

The measurement was conducted in the same manner as in Example 13 except for changing the inspection liquid from HFE-7200 to HFE-7100 (δ=13.6 mN/m). As is clear from the results shown in Table 2, it was found that the maximum pore size can also be measured using HFE-7100 as the inspection liquid.

### Example 20

The measurement was conducted in the same manner as in Example 13 except for changing the gas from air to nitrogen. As is clear from the results shown in Table 2, it was found that the maximum pore size can also be measured using nitrogen as the gas.

### Example 21

500 ml of HFE-7200 (δ=13.6 mN/m) was caused to permeate through the dried filter E prepared in the same manner as described above at 0.098 MPa to fill the filter with HFE-7200. The filter was then connected with the device shown in FIG. 1, and the air pressure was slowly increased to measure the flow rate of permeated air.

50 ml of water was caused to permeate through the filter A at 0.196 MPa to prepare the filter F wetted with water. After removing the water from the nozzle of the filter F, 5 ml of ethanol was filtered at 1.96 kPa. After drying the filter for five minutes using air at 0.098 MPa, 20 ml of ethanol was filtered. After removing the ethanol from the nozzle of the filter A, the filter was dried for five minutes using air at 0.098 MPa. 500 ml of HFE-7200 was filtered to fill the filter with HFE-7200. The filter was then connected with the device shown in FIG. 1, and the air pressure was slowly increased by controlling the air pressure using a pressure regulator 2, and the pressure of the permeated air was measured. As is clear from the results shown in Table 2, it was found that the maximum pore size can be measured by replacing the liquid inside the filter F wetted with water with ethanol and HFE-7200 in that order and causing the gas to permeate through as well as the filter E which was not wetted with water.

### Example 22

The measurement was conducted in the same manner as in Example 19 except for using a filter G with an average water permeable pore size of 13.9 nm (maximum pore size measured in Example 22 as described later was 28.5 nm) and a filter H obtained by wetting the filter G with water. As is clear from the results shown in Table 2, it was found that the maximum pore size can be measured by replacing the liquid inside the filter H wetted with water with ethanol and HFE-7200 in that order and causing the gas to permeate through as well as the filter G which was not wetted with water.

### Example 23

The measurement was conducted in the same manner as in Example 21 except for changing ethanol to IPA. As is clear from the results shown in Table 2, it was found that the maximum pore size can also be measured using IPA as the amphiphilic liquid.

### Example 24

The measurement was conducted in the same manner as in Example 21 except for changing HFE-7200 to HFE-7100 (δ=13.6 m N/m). As is clear from the results shown in Table 2, it was found that the maximum pore size can also be measured using HFE-7100 as the inspection liquid.

### Example 25

The measurement was conducted in the same manner as in Example 21 except for changing air to nitrogen. As is clear from the results shown in Table 2, it was found that the maximum pore size can also be measured using nitrogen as the gas.

### Comparative Example 1

HFE-7200 was filtered through the filter B at 0.098 MPa. As a result, HFE-7200 permeated through to only a small extent, and air did not permeate through even at a pressure of 2.5 MPa. Therefore, the integrity test and the maximum pore size measurement could not be performed.

### Comparative Example 2

The measurement was conducted in the same manner as in Example 2 except for changing the mixture of the amphiphilic liquid and the liquid with a surface tension of 5 to 20 mN/m from the IPA/HFE-7200 (30/70 vol %) liquid to an IPA/HFE-7200 (7/93 vol %) liquid. As a result, the IPA/HFE-7200 (7/93 vol %) liquid permeated through to only a small extent, and air did not permeate through even at a pressure of 2.5 MPa. Therefore, the integrity test and the maximum pore size measurement could not be performed.

### Comparative Example 3

The measurement was conducted in the same manner as in Example 2 except for changing HFE-7200 to 30 vol % IPA with a surface tension of 27.8 mN/m. As a result, air did not permeate through even at a pressure of 2.5 MPa. Therefore, the integrity test and the maximum pore size measurement could not be performed.

### Comparative Example 4

HFE-7200 was filtered through the filter B wetted with water at 0.098 MPa without filtering the amphiphilic liquid. As a result, air did not permeate through even at a pressure of 2.5 MPa. Therefore, the integrity test and the maximum pore size measurement could not be performed.

### Comparative Example 5

The measurement was conducted in the same manner as in Example 1 except for changing HFE-7200 to a 30 wt % IPA solution (δ=27.8 mN/m). As a result, air did not permeate through even at a pressure of 2.5 MPa. Therefore, the integrity test and the maximum pore size measurement could not be performed.

[Table 2]

TABLE 2

| | Example | Example | Example | Example | Example | | | | | |
|---|---|---|---|---|---|---|---|---|---|---|
| | 12 | 13 | 14 | 15 | 16 | Example 17 | Example 18 | Example 19 | Example 20 | Example 21 |
| Filter type | A, B | A, B | C, D | C, D | A, B | A, B | A, B | A, B | A, B | E, F |
| Hydrophilic | Water | Water | Water | Water | Water | Sodium | Water | Water | Water | Water |
| solvent | | | | | | chloride | | | | |
| Amphiphilic | IPA | 30 vol % | IPA | 30 vol % | 10 vol % | 10 vol % | EtOH | 30 vol % | 30 vol % | EtOH |
| liquid | | IPA/ | | IPA/ | IPA/ | IPA/ | | IPA/ | IPA/ | |
| | | 70 vol % | | 70 vol % | 90 vol % | 90 vol % | | 70 vol % | 70 vol % | |
| | | HFE-7200 | | HFE-7200 | HFE-7200 | HFE-7200 | | HFE-7200 | HFE-7200 | |
| Inspection liquid | HFE-7200 | HFE-7200 | HFE-7200 | HFE-7200 | HFE-7200 | HFE-7200 | HFE-7200 | HFE-7100 | HFE-7200 | HFE-7200 |
| Surface tension | 13.6 | 13.6 | 13.6 | 13.6 | 13.6 | 13.6 | 13.6 | 13.6 | 13.6 | 13.6 |
| (mN/m) | | | | | | | | | | |
| Gas | Air | Air | Air | Air | Air | Air | Air | Air | Nitrogen | Air |
| Pressure 1 (MPa) | 0.951 | 0.951 | 1.100 | 1.100 | 0.951 | 0.951 | 0.951 | 0.960 | 0.956 | 1.279 |
| Pressure 2 (MPa) | 0.960 | 0.960 | 1.100 | 1.121 | 0.977 | 0.960 | 0.970 | 0.970 | 0.970 | 1.271 |
| Maximum pore | 40.9 | 40.9 | 35.5 | 35.5 | 40.9 | 40.9 | 40.9 | 40.5 | 40.7 | 30.4 |
| size 1 (nm) | | | | | | | | | | |
| Maximum pore | 40.5 | 40.5 | 35.5 | 34.7 | 39.8 | 40.5 | 40.1 | 40.1 | 40.1 | 30.6 |
| size 2 (nm) | | | | | | | | | | |

| | | | | | Comparative | Comparative | Comparative | Comparative | Comparative |
|---|---|---|---|---|---|---|---|---|---|
| | Example 22 | Example 23 | Example 24 | Example 25 | example 1 | example 2 | example 3 | example 4 | example 5 |
| Filter type | G, H | E, F | E, F | E, F | A, B | A, B | A, B | E, F | E, F |
| Hydrophilic | Water | Water | Water | Water | Water | Water | Water | Water | Water |
| solvent | | | | | | | | | |
| Amphiphilic | EtOH | IPA | EtOH | EtOH | — | 7 vol % IPA/ | 30 vol % | — | EtOH |
| liquid | | | | | | 93 vol % | IPA/ | | |
| | | | | | | HFE-7200 | 70 vol % | | |
| | | | | | | | HFE-7200 | | |
| Inspection liquid | HFE-7200 | HFE-7200 | HFE-7100 | HFE-7200 | HFE-7200 | HFE-7200 | IPA | HFE-7200 | IPA |
| Surface tension | 13.6 | 13.6 | 13.6 | 13.6 | 13.6 | 13.6 | 13.6 | 13.6 | 13.6 |
| (mN/m) | | | | | | | | | |
| Gas | Air | Air | Air | Nitrogen | Air | Air | Air | Air | Air |
| Pressure 1 (MPa) | 1.365 | 1.284 | 1.275 | 1.280 | 0.951 | 0.951 | 0.951 | 0.951 | 0.951 |
| Pressure 2 (MPa) | 1.355 | 1.285 | 1.284 | 1.283 | — | — | — | — | — |
| Maximum pore | 28.5 | 30.3 | 30.4 | 30.4 | 40.9 | 40.9 | 40.9 | 30.4 | 30.4 |
| size 1 (nm) | | | | | | | | | |
| Maximum pore | 28.7 | 30.3 | 30.3 | 30.3 | Did not | Did not | Did not | Did not | Did not |
| size 2 (nm) | | | | | permeate | permeate | permeate | permeate | permeate |

Pressure 1: Pressure measured when causing gas to permeate through dried filter
Pressure 2: Pressure measured when causing gas to permeate through filter wetted with hydrophilic solvent
Maximum pore size 1: Maximum pore size of filter measured when causing gas to permeate through dried filter
Maximum pore size 2: Maximum pore size of filter measured when causing gas to permeate through filter wetted with hydrophilic solvent

### Test Example 3

A PVDF porous hollow fiber membrane with an average water permeable pore size of 17.8, 18.5, 19.4, 19.7, 22.0, or 24.3 nm was manufactured according to the method disclosed in International Publication WO 2004/035180 to formed into a filter with a membrane area of 0.001 m².

The forward flow measurement was conducted in the same manner as in Test Example 1 except for changing the measurement pressure to 1.18 MPa. As a result, the flow rate of each filter was 8.7 NL/min/m² (17.8 nm), 8.9 NL/min/m² (18.5 nm), 12.2 NL/min/m² (19.4 nm), 14.0 NL/min/m² (19.7 nm), 31.9 NL/min/m² (22.0 nm), and 43.9 NL/min/m² (24.3 nm).

The virus removal capability was measured using each 0.001 m² filter. A porcine parvovirus (PPV) was used as an indicator virus. Human globulin and PPV were added to D-MEM to a concentration of 3 vol % and 10⁶⁻⁷ TCID₅₀/ml, respectively. 100 ml of the resulting solution was filtered at 0.294 MPa to measure the porcine parvovirus removal capability. The porcine parvovirus removal rate (Φ) of each filter was 6.00 (17.8 nm), 6.00 (18.5 nm), 5.50 (19.4 nm), 4.67 (19.7 nm), 3.30 (22.0 nm), and 2.77 (24.3 nm). As shown in FIG. 2, a definite correlation was observed between the porcine parvovirus removal rate and the forward flow rate.

### Example 26

The forward flow measurement was conducted in the same manner as in Example 2 except for using the filter with each pore size and changing the measurement pressure to 1.18 MPa. The flow rate of each filter was 8.0 NL/min/m² (17.8 nm), 8.4 NL/min/m² (18.5 nm), 11.5 NL/min/m² (19.4 nm), 13.6 NL/min/m² (19.7 nm), 29.3 NL/min/m² (22.0 nm), or 408 NL/min/m² (24.3 nm). As shown in FIG. 2, it was found that a definite correlation exists between the porcine parvovirus removal rate and the forward flow rate. From these results, it was found that the same results as those for the filter which was not wetted with water were obtained by treating the filter wetted with water according to the method of the present invention, whereby the integrity test that is the alternate index of the virus removal capability can be performed.

### Example 27

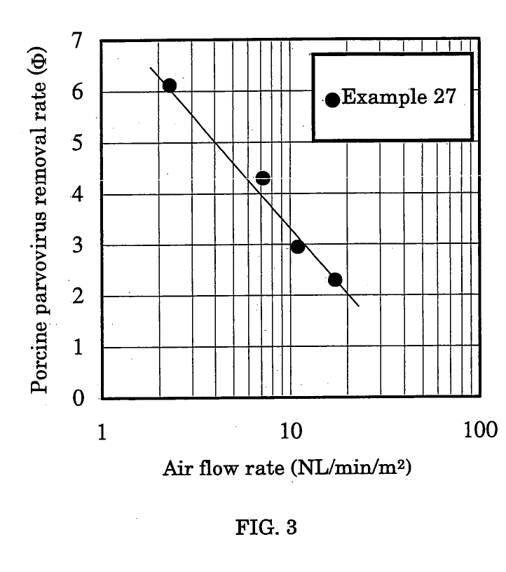

A PVDF porous hollow fiber membrane with an average water permeable pore size of 13.9 to 18.3 nm was manufactured in the same manner as described above, and was formed into a filter with a membrane area of 0.1 or 0.001 m². The flow rate of air permeated through each filter wetted with water was measured by using the same method as in Example 6. The virus removal capability was then measured using each 0.001 m² filter. A porcine parvovirus was used as an indicator virus, and D-MEM solution containing 5 vol % fetal bovine serum was prepared so that the concentration of the virus in the solution was 10⁶⁻⁷ TCID₅₀/ml. 80 ml of the resulting solution was filtered at 0.3 MPa, and the porcine parvovirus removal capability was measured. The virus concentration in the filtrate was measured and the virus removal capability was calculated using the above equation (3). As a result, as shown in FIG. 3, it was found that a definite correlation exists between the porcine parvovirus removal capability and the flow rate of permeated air. From these results, it was found that the present invention can be used for the integrity test as the alternate index of the virus removal capability.

### INDUSTRIAL APPLICABILITY

The gas permeation method for a porous membrane of the present invention can be utilized for the pore size measurement method and the integrity test method, and the pore size measurement method and the integrity test method can be suitably utilized in the field of a virus removal membrane, microfiltration membrane, or ultrafiltration membrane.

1. A method for causing a gas to permeate through a porous membrane having a pore size of 100 nm or less and wetted with a hydrophilic solvent at a pressure of 2.5 MPa or less, comprising:
(a) a step of causing an amphiphilic liquid or a mixture of an amphiphilic liquid and a liquid with a surface tension of 5 to 20 mN/m to permeate through the porous membrane wetted with the hydrophilic solvent;
(b) a step of causing an inspection liquid with a surface tension of 5 to 20 mN/m to permeate through the porous membrane after the step (a); and
(c) a step of causing a gas to permeate through the porous membrane at a pressure of 2.5 MPa or less after the step (b).

2. The method according to claim 1, wherein the hydrophilic solvent is water or a sodium chloride solution.

3. The method according to claim 1, wherein the amphiphilic liquid is any of an alcohol compound, a ketone compound, an ether compound, and an ester compound.

4. The method according to claim 1, wherein the amphilic liquid is any of methyl alcohol, ethyl alcohol, propanol, or isopropanol.

5. The method according to claim 1, wherein the inspection liquid has compatibility with the amphiphilic liquid.

6. The method according to claim 1, wherein the inspection liquid is a fluoride.

7. The method according to claim 1, wherein the inspection liquid is any of an ether-type fluorocarbon compound, a carbonyl-type fluorocarbon compound, an ester-type fluorocarbon compound, a COF-type fluorocarbon compound, an OF-type fluorocarbon compound, and a peroxide-type fluorocarbon compound.

8. The method according to claim 1, wherein the inspection liquid is a hydrofluoro ether.

9. The method according to claim 1, wherein the hydrofluoro ether is C₄F₉OC₂H₅ or C₄F₉OCH₃.

10. The method according to claim 1, wherein a volume percentage of the amphiphilic liquid in the mixture of the amphiphilic liquid and the liquid with a surface tension of 5 to 20 mN/m is 10 to 100 vol %.

11. The method according to claim 1, wherein the gas is a gas inert to the inspection liquid and the porous membrane.

12. The method according to claim 1, wherein the gas is any of air, nitrogen, helium, argon, carbon dioxide, and hydrogen.

13. The method according to claim 1, wherein the porous membrane is any of a microfiltration membrane, an ultrafiltration membrane, and a virus removal membrane.

14. The method according to claim 1, wherein the porous membrane is any of a polyvinylidene fluoride membrane and a polysulfone membrane.

15. The method according to claim 1, wherein the pore size is 50 nm or less as a maximum pore size.

16. The method according to claim 1, wherein the pressure when causing the gas to permeate is 2.0 MPa or less.

17. The method according to claim 1, wherein the porous membrane is a virus removal porous membrane; the method further comprises (d) a step of judging integrity of the porous membrane against viruses by measuring, after causing the gas to permeate through, a flow rate of the permeated gas or a pressure changed by the permeation of the gas; and the gas permeation method is utilized for an integrity test method for the virus removal porous membrane.

18. The method according to claim 17, wherein the test method in the step of judging the integrity is any one of a bubble point method, a forward flow method, a diffusion method, and a pressure hold method.

19. The method according to claim 1, further comprising (d) a step of judging the pore size of the porous membrane by measuring, after causing the gas to permeate through, a flow rate of the permeated gas or a pressure changed by the permeation of the gas; and wherein the gas permeation method is utilized for a pore size measurement method for the porous membrane.
